(19) United States
(12) Patent Application Publication
(10) Pub. No.: US 2020/0226772 A1
(43) Pub. Date: Jul. 16, 2020

(54) ANTI-COUNTERFEITING METHOD BASED ON FEATURE OF SURFACE TEXTURE IMAGE OF PRODUCTS

(71) Applicant: Hunan Agricultural Information and Engineering Institute, Changsha (CN)

(72) Inventors: Xuyou XIANG, Changsha,Hunan (CN); Chao ZHOU, Changsha,Hunan (CN); Yi HE, Changsha,Hunan (CN); Sainan LUO, Changsha,Hunan (CN); Xuewen LIU, Changsha,Hunan (CN)

(21) Appl. No.: 16/740,590

(22) Filed: Jan. 13, 2020

(30) Foreign Application Priority Data
Jan. 13, 2019 (CN) 201910029462.9

(51) Int. Cl. G06T 7/42; G06K 7/14

(52) U.S. Cl. CPC G06T 7/42; G06K 7/1417; G06K 7/1452; G06K 7/1456; G06K 7/1443

(57) ABSTRACT

Disclosed is an anti-counterfeiting method based on a feature of a surface texture image of a product, including: obtaining a tag with a unique identity; implanting the tag into a product identification area with a unique texture feature on a surface of the product; collecting an image of the product identification area on the surface of the product implanted with the tag as an official product image using an image acquisition device; adopting a computing method of an eigenvalue of a multi-partition texture image to acquire a feature of the official product image; authenticating a user product image to be identified using a matching method of the texture image eigenvalue of similar partitions based on the identity of an image of the tag and the feature of the official product image to determine an authenticity.

### CROSS-REFERENCE TO RELATED APPLICATIONS

This application claims the benefit of priority from Chinese Patent Application No. 201910029462.9, filed on Jan. 13, 2019. The content of the aforementioned application, including any intervening amendments thereto, is incorporated herein by reference in its entirety.

### TECHNICAL FIELD

The present invention relates to image anti-counterfeiting, and more particularly to an anti-counterfeiting method based on a feature of a surface texture image of a product.

### BACKGROUND

At present, there are several anti-counterfeiting technologies mainly including: material anti-counterfeiting, ink anti-counterfeiting, structural texture anti-counterfeiting and RFID anti-counterfeiting. These technologies have played an effective role for a long time, but they still have some shortcomings, especially the anti-counterfeiting method based on structural texture.

Chinese Patent Application No. 99801139. 8, titled “anti-counterfeiting method based on structural texture”, discloses an anti-counterfeiting method, in which according to the texture features, a set of codes is generated through specific permutation and combination as a feature code of a product. In the determination of the authenticity of the product, it is necessary to manually identify and determine whether a specified eigenvalue exists on the surface of the product according to a specified method, or to determine the legality online after the eigenvalue is calculated, or to acquire a texture picture online after the eigenvalue is calculated to determine whether the real object is consistent with the picture through artificial comparison, which is specifically described in the Chinese Patent Publication No. 105184594A. Obviously, these methods have many defects, such as difficult operation, excessive manual intervention and inordinate influence of human factors on the authentication.

An anti-counterfeiting method based on structural texture, represented by Chinese Patent Publication No. 108537555 A, titled “anti-counterfeiting method of automatically identifying authenticity based on non-dedicated APP” focuses on using the physical characteristics of a structural tag to achieve the determination. Although this method reduces the manual operation in workload and difficulty, it still fails to completely to eliminate the interference caused by human factors. Moreover, the authentication process will destroy the physical structure of the product or require special instruments and equipment, which is unacceptable in some situations, for example, in the purchase of a gift. In addition, too “micro” details will make a real product be identified as a “fake” because of the transportation of products in the sales process, affecting the interests of the producers and sellers.

In other words, the most critical problem in the current anti-counterfeiting technologies based on structural texture is the lack of a convenient method capable of programmatically achieving automatic nondestructive tagging and authentication only based on characteristics of the product. Therefore, it is of great significance to develop an anti-counterfeiting method for identifying the authenticity of products based on features of a surface texture image of a product.

### SUMMARY

An object of the invention is to provide an anti-counterfeiting method for identifying the authenticity of a product based on a feature of a surface texture image of the product to overcome the defects in the prior art, where the multi-partition computation of an eigenvalue and the similar partition matching of an eigenvalue are employed to make the eigenvalue more comprehensive and accurately reflect differences of the texture images.

The following technical solutions are adopted to achieve the above objects.

The invention provides an anti-counterfeiting method based on the image feature of product surface texture, comprising:

(1) obtaining a tag with a unique identity;

(2) implanting the tag into a product identification area with a unique texture feature on a surface of the product;

(3) collecting an image of the identification area on the surface of the product implanted with the tag as an official product image using an image acquisition device; and adopting a multi-partition computing method of a texture image eigenvalue to acquire a feature of the official product image;

(4) matching and authenticating a user product image to be identified using a similar partition matching method of the texture image eigenvalue based on the identity of an image of the tag and the feature of the official product image to determine an authenticity.

The step (1) comprises:

(1-a) obtaining a structure of the tag with the unique identity;

wherein the structure of the tag comprises an encoder and a locator; the encoder has unique serial number of the product, and the locator comprises at least four anchor points provided at any position outside the encoder, the anchor points are used as reference points in subsequent image transformation;

(1-b) obtaining the tag based on the structure of the tag;

(1-c) collecting an image of the tag using the image acquisition device;

(1-d) obtaining coordinates bPi of the anchor points in the image of the image of the tags in a coordinate system with any one of the anchor points as an origin using an image analyzing and processing method, wherein i is a number of the anchor points and is selected from 1, 2, 3 . . . and n; and

(1-e) storing the tag, the image of the tag and an identity of the image of the tag in a memory;

wherein the identity of the image of the tag comprises the coordinates of the anchor points in the image of the tag, a visual distance and a quality of the image of the tag during the collection of an image of the structure of the tag and a serial number of the tag.

in step (1-a), the structure of the tag also comprises a delimiter and a directing device;

the delimiter is a boundary line of the locator; and

the directing device is a direction of the boundary line

The step (3) comprises:

(3a) collecting the image of the product identification area on the surface of the product implanted with the tag using the image acquisition device to obtain a first image;

(3b) subjecting the first image to perspective transformation according to a coordinate of respective anchor points of the tag in the first image using the image analyzing and processing method to obtain the official product image;

(3c) dividing the official product image into a plurality of valid sub-partitions using a preset sub-partition generation strategy;

(3d) obtaining a texture category of respective sub-partitions and an association algorithm of the sub-partitions; and obtaining an eigenvalue of respective valid sub-partitions according to the texture category and the association algorithm;

(3e) obtaining a location of respective valid sub-partitions according to a location of respective sub-partitions relative to the image of the tag in the official product image; and

(3f) obtaining a serial number of the official product image; and storing the serial number of the official product image, the sub-partition generation strategy, the feature of the official product image and the official product image in the memory in an one-to-one correspondence;

wherein the feature of the official product image comprises the texture category of respective sub-partitions, the association algorithm of the sub-partitions, the location of respective sub-partitions and the eigenvalue of respective sub-partitions in the official product image.

Optionally, the step (3) also comprises:

(3g) repeating inspection of the feature of the official product image, if the features f official products image are not unique, adjusting the texture category of the sub-partition, repeating steps s3d-s3f to obtain the feature of the official product image again.

The step (3b) comprises:

(3b-1) acquiring the coordinate pPi of respective anchor points of the tag in the first image using the image analyzing and processing method;

(3b-2) obtaining a perspective transformation matrix iM of the first image using the coordinate pPi of respective anchor points of the first image as a source image characteristic point of the perspective transformation and bPi+pPx as a target image characteristic point of the perspective transformation, wherein i is the number of the anchor points and is selected from 1, 2, 3 . . . and n, and x is a number of the anchor point used as an origin; and

(3b-3) subjecting the first image to perspective transformation using the perspective transformation matrix iM of the first image to obtain the official product image.

Optionally, the step (3c) also comprises:

filtering all sub-partitions, eliminating the sub-partition of the image that does not intersect with the tag to acquire the valid sub-partition.

the step (3d) includes:

(3d-1) acquiring the texture category of respective valid sub-partitions;

(3d-2) acquiring the association algorithm of the sub-partitions based on the texture category of respective valid sub-partitions; and

(3d-3) obtaining the eigenvalue of respective valid sub-partitions using the association algorithm of the sub-partitions.

the step (3f) comprises:

(3f-1) decoding an information from the encoder in the official product image to obtain the serial number of the tag; and

(3f-2) storing the official product image, the sub-partition generation strategy, the feature of the official product image and the serial number of the official product image in the memory in the one-to-one correspondence.

In an embodiment, the step (3f-2) includes:

obtaining a data entity containing the feature of the official product image based on the feature of the official product image; storing the official product image, the sub-partition generation strategy, and the data entity in a memory using the serial number of the tag as a key.

the step (4) comprises:

(4a) collecting an image of an identification area of a user product to be identified using the image acquisition device to obtain a second image;

(4b) subjecting the second image to perspective transformation to acquire a user product image according to a coordinate of respective anchor points of the tag in the second image using the image analyzing and processing method;

(4c) identifying a serial number of the tag in the user product image to obtain corresponding official product image information;

(4d) dividing the user product image into a plurality of second sub-partitions according to the sub-partition generation strategy of the official product image corresponding to the serial number of the tag; and

(4e) performing matching on the second valid sub-partitions based on the location of the first sub-partitions of the official product image corresponding to the serial number of the tag and the association algorithm of the first sub-partitions to determine an authenticity of the user product to be identified.

The step (4b) includes:

(4b-1) obtaining a coordinate cPi of respective anchor points of the tag in the second image using the image analyzing and processing method;

(4b-2) acquiring a second image perspective transformation matrix cM by using the coordinate cPi of the anchor points in the second image as a source image feature point of the perspective transformation and bPi+cPx as a target image feature point of the perspective transformation; and

(4b-3) subjecting second image to perspective transformation using the second image perspective transformation matrix cM to obtain the user product image.

In an embodiment, step (4e) includes:

(4e-1) obtaining a location of respective second sub-partitions of the user product image according to the location of the first sub-partition relative to the image of the tag in the official product image;

(4e-2) determining whether there is at least one of the second sub-partitions in the user product image matching any one of the first sub-partitions in the official product image with respect to location; if not, giving a conclusion that the product to be identified is fake; if yes, proceeding to step (4e-3);

(4e-3) obtaining any pair of the second sub-partition cr of the user product image and the first sub-partition ir of the official product image matching each other; and obtaining an eigenvalue of the second sub-partition cr of the user product image according to an association algorithm of first sub-partition ir of the official product image;

(4e-4) determining whether the eigenvalue of the second sub-partition cr of the user product image is consistent with the eigenvalue of the first sub-partition ir of the official product image, if yes, giving a conclusion that the eigenvalue of the second sub-partition cr of the user product image is consistent with the eigenvalue of the first sub-partition ir of the official product image, if not, proceeding to step (4e-5);

(4e-5) generating a plurality of similar partitions based on the second sub-partition cr of the user product image; wherein the similar partitions are the same with the second sub-partition cr of the user product image except for the position in the user product image;

(4e-6) sequentially obtaining eigenvalues of respective similar partitions according to the association algorithm of the second sub-partition ir of the official product image; determining whether the eigenvalue of at least one similar partition is consistent with and the eigenvalue of the first sub-partition ir of the official product image, if yes, giving a conclusion that there is at least one similar partition having an eigenvalue consistent with the eigenvalue of the first sub-partition ir of the official product image; if not, giving a conclusion that there is no similar partition having an eigenvalue consistent with the eigenvalue of the first sub-partition it of the official product image; repeating steps (4e-3)-(4e-6) to compare all second sub-partitions with all first sub-partitions; and

(4e-7) obtaining a matching rate between the first sub-partitions and the second sub-partitions according to the comparison result; in the case of the matching rate greater than a preset threshold, making a conclusion that the user product to be identified is authentic; wherein the matching rate is calculated according to the following formula: matching rate=(the number of second sub-partitions matching the first sub-partitions/total number of the second sub-partitions)×100%.

Compared to the prior art, the invention has the following beneficial effects.

The invention adopts the computation of eigenvalue of multiple partitions and the matching of eigenvalue of similar partitions to make the eigenvalue more comprehensively and accurately reflect the difference between texture images, thus effectively reducing misjudgment and facilitating the improvement in the efficiency and accuracy of the identification and authentication of a computer programming product.

### BRIEF DESCRIPTION OF THE DRAWINGS

FIG. 1 schematically shows a structure of a tag according to an embodiment of the invention;

FIG. 2 schematically shows the relationship between a pixel coordinate system and anchor points in the tag structure of an embodiment of the invention;

FIG. 3 schematically shows a first image of an embodiment of the invention;

FIG. 4 schematically shows a standardized official product image of the embodiment of the invention;

FIG. 5 schematically shows the result of equidistant longitudinal and latitudinal partitioning of the sub-partition generation strategy according to the embodiment of the invention;

FIG. 6 schematically shows a second image of the embodiment of the invention;

FIG. 7 schematically shows a standardized user product image of the embodiment of the invention; and

FIG. 8 is a flow chart showing an anti-counterfeiting method based on features of a surface texture image of a product according to the embodiment of the invention.

### DETAILED DESCRIPTION OF EMBODIMENTS

The invention will be described below in detail with reference to the embodiments to make it better illustrated and understood.

### Embodiment 1

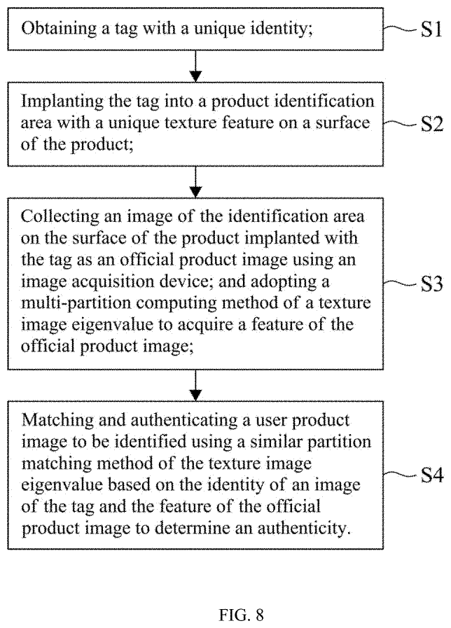

As shown in FIG. 8, the embodiment provides an anti-counterfeiting method based on a feature of a surface texture image of a product, which is specifically described as follows.

(1) A tag with a unique identity is acquired.

In this embodiment, the tag is used for tagging a product, which has the functions of locating, orientating, delimitating and self-tagging, and is unique. An image of the tag is used for unifying an official product image and a user product image into the same computing environment. The official product image is a legal product image, that is, the image of an official product which is legally produced and recorded. The official product image is also unique. The user product image is an image of a product to be identified.

Step (1) is specifically described as follows.

(1-a) A tag structure with unique identity is obtained.

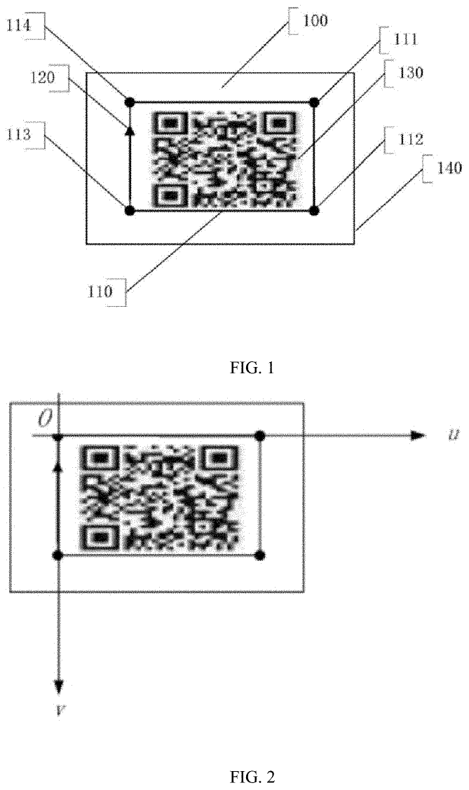

As shown in FIG. 1, the structure of the tag includes an encoder 120 and a locator 110, where the encoder 120 has unique serial number of the product, and the locator 110 includes four points anchor provided at any position outside the encoder 120, which are used as anchor points.

Preferably, the tag structure also includes a delimiter 140 and a directing device 130; the delimiter 140 is a boundary line of the locator 110; the directing device 130 is a direction of the boundary line.

The encoder 120 has the unique serial number of the product, which can be one of a graph, a string, a barcode and a qr code, or a combination of a string, a barcode and a qr code. The encoder has unique serial number within the scope of the application.

In this embodiment, the locator 110 includes four anchor points which serve as the reference points for various image transformation operations in the following steps. Any one of the four points is taken as a feature point for perspective transformation. As shown in FIG. 1, icon 111, icon 112, icon 113 and icon 114 are the four anchor points of locator 110, and also are the feature points in the image transformation, such as perspective transformation, which are simply referred to as transformation reference points. The four anchor points are distributed in a rectangle, and each point is at the vertex of the rectangle, and the upper left corner of the rectangle is icon 114. In an embodiment, any 4 points can be selected to form any shape, but the points and the shape cannot be changed after being determined.

Preferably, the structure of the tag also includes a delimiter 140, which is the boundary line of the locator 110. In an embodiment, the four lines surrounding the tag encoder 120 include a left line, an upper line, a right line and a lower line. The left line is a line from the anchor point 113 to the anchor point 114; the upper boundary line is a line from the anchor point 114 to the anchor point 111; the right line is a line from the anchor point 111 to the anchor point 112; and the lower boundary line is a line from the anchor point 112 to the anchor point 113. The four boundary lines form a rectangle. In practical application, the shape made by the four lines is not limited to the rectangle shown in this embodiment, but can be set to any other shapes, such as oval lamp.

The directing device 130, preferably, the tag structure includes a directing device 130, which is a direction of a boundary line. In the embodiment of the invention, the directing device 130 is a straight line with an arrow pointing from the anchor point 113 to the anchor point 114, and the arrow is upward and parallel to the left line.

S1b. The tag is obtained based on the structure of the tag.

The tag is created for implantable product surface based on the structure of the tag.

(1-c) An image of the tag is collected using the image acquisition device.

An image of the tag structure obtained in step 1-b is captured by an imaging device, in order to obtain an anti-counterfeiting image of the tag. Preferably, during shooting, the range of visibility bL and quality bD are set in advance, and a sight line is vertically aligned with a center of the structure of the tag. Preferably, bL is 120 mm and bD is 300 DPI.

(1-d) Coordinates bPi of the anchor points in the image of the image of the tags in a coordinate system with any one of the anchor points as an origin is obtained using an image analyzing and processing method, where i is a number of the anchor points and is selected from 1, 2, 3 . . . and n.

As shown in FIG. 2, based on the method of analyzing and processing the image, the icon 114 is taken as an origin to obtain the coordinates of all anchor points in the pixel coordinate system with the icon 114 as the origin, that is, the reference points of perspective transformation in the subsequent steps, bPi; where i is a number of the anchor point. In this embodiment, the coordinates of the four anchor points are marked (bP1,bP2,bP3,bP4).

(1-e) The tag, the image of the tag and an identity of the image of the tag are stored in a memory.

The identification of the image of the tag comprises the coordinates of the anchor point of the image of the tag, rang of visibility and quality when acquiring the structure image of the tag and the serial number of the tag. For example, the image of the tag, the coordinates of the image of the tag anchor points (bP1, bP2, bP3,bP4), and the rang of visibility bL and the quality bD when acquiring the structure image of the tag are stored in a memory.

Optionally, tags, image of the tags and identification of image of the tags are stored in a database, such as a server or a cloud platform that can be used for network communication.

(2) The tag is implanted into a product identification area with a unique texture feature on a surface of the product.

When being used, the tag obtained in step (1) is planted in a product identification area which is a surface area with unique texture characteristics existing in each product. Within the range of product, each product has a unique and stable texture pattern at similar surface position. After the tag is implanted into the product identification area with a unique texture feature on a surface of the product, the tag and the product form a whole. If there is a displacement, the displacement distance is less than a predetermined value, such as 0.01 mm.

(3) An image of the identification area on the surface of the product implanted with the tag as an official product image is collected using an image acquisition device; and a multi-partition computing method of a texture image eigenvalue is adopted to acquire a feature of the official product image

The official products are products recognized by producers. The official products are solid in structure or solid after packaging. The surface of products has a unique texture, which is of uniqueness within the range of the product. The surface area where the texture is located is called an identification area. After a image of the tag is implanted in an appropriate position in the identification area in a one-to-one correspondence manner between the product and the image of the tag in step (2), the image of the tag and the product form a whole, and the displacement distance is less than a predetermined value. User products are products suspected of being official products to be identified. Through the steps, the official product image and the eigenvalue thereof are obtained using a multi-partition calculating method of a texture image eigenvalue, which can be used to verify the authenticity of the user product.

(3a) The image of the product identification area on the surface of the product implanted with the tag is collected using the image acquisition device to obtain a first image.

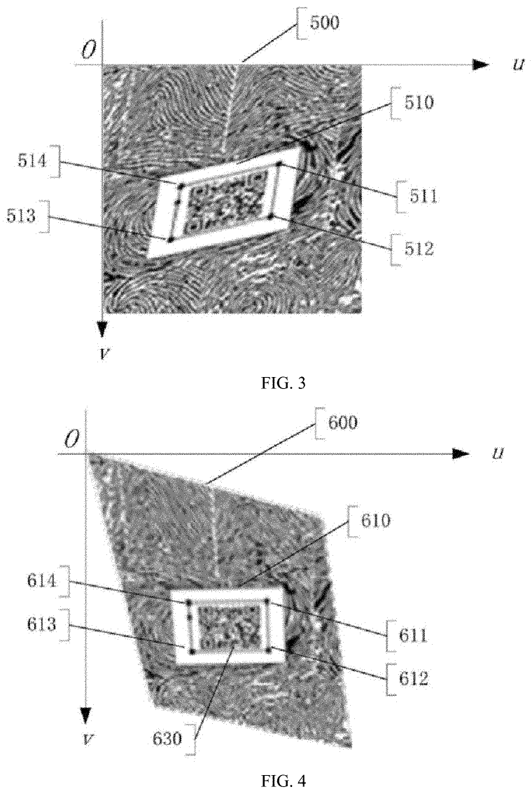

As shown in FIG. 3, a first image 500 is obtained using an imaging device to photograph a product identification area on the surface of the product implanted with a tag. There is a relatively complete image of the tag 510 in the first image 500.

(3b) The first image is subjected to perspective transformation according to a coordinate of respective anchor points of the tag in the first image using the image analyzing and processing method to obtain the official product image.

The image analyzing and processing method is used to perform perspective transformation on the first image and standardize the first image to obtain official product image.

(3b-1) The coordinate pPi of respective anchor points of the tag in the first image is obtained using the method of analyzing and processing the image.

The method of analyzing and processing the image is adopted to transform the perspective of the first image and standardize the first image to obtain the official product image.

In this embodiment, the coordinates of the anchor points 511, 512, 513, 514 in the first image 500 are acquired to calculate, as coordinates (pP1, pP2, pP3, pP4) of the transformation reference point.

(3b-2) A perspective transformation matrix iM of the first image is obtained using the coordinate pPi of respective anchor points of the first image as a source image characteristic point of the perspective transformation and bPi+pPx as a target image characteristic point of the perspective transformation, wherein i is the number of the anchor points and is selected from 1, 2, 3 . . . and n, and x is a number of the anchor point used as an origin;

In this embodiment, the coordinates of the first image anchor points (pP1, pP2, pP3, pP4) are used as a source image characteristic point of the perspective transformation, and (BP1+IP4, BP2+IP4, BP3+IP4, BP4+IP4) are used as the target image characteristic points of the perspective transformation to obtain the first image perspective transformation matrix iM. Where the coordinate values of bPk (k=1, 2, 3, 4) and iP4 are (u1, v1) and (u2, v2) respectively, and bPk+iP4 generates new coordinates with a value of (u3, v3), where U3=U1+U2, V3=V1+V2.

(3b-3) The first image is subjected to perspective transformation using the perspective transformation matrix iM of the first image to obtain the official product image.

The first image is subjected to perspective transformation using the perspective transformation matrix iM of the first image 500 to obtain the official product image 600.

(3c) The official product image is divided into a plurality of valid sub-partitions using a preset sub-partition generation strategy.

A preset sub-partition generation strategy is used. In order to make the description clearer, the sub-partition generation strategy in this embodiment is named Pstrategy. In this embodiment, Pstrategy, the sub-partition generation strategy, is to generate sub-partitions by segmenting images with equal distance longitude and latitude lines. The identity image 600 is divided into a plurality of sub-partitions {R}, based on the sub-partition generation strategy Pstrategy.

Preferably, A sub-partition screening process is executed, and some sub-partitions with limited functions are removed. The removed sub-partitions do not participate in the calculation of legal feature generation.

Before step (3d) is executed, a sub-partition screening process can be executed to remove some sub-partitions with limited functions.

Preferably, sub-partitions adjacent to the image of the tag 610 are selected as much as possible.

(3d) A texture category of respective sub-partitions and an association algorithm of the sub-partitions is obtained; and an eigenvalue of respective valid sub-partitions is obtained according to the texture category and the association algorithm.

(3d-1) The texture category of respective valid sub-partitions is acquired.

The texture category Ttype of respective valid sub-partitions is acquired.

According to the texture characteristics of the product surface sub-partition, the machine classification or manual definition can be used to obtain the texture category of the sub-partition. The machine tagging refers to the use of a computer program implemented by software or hardware to determine the feature of the surface texture image of the product and define the category sub-partition texture. For example, by machine recognition, the sub-partitions 640, 641 and 642 are respectively defined as a hand print type, a stripe type and a spot type.

The artificial defining refers to the artificial determination of the texture feature of respective sub-partitions and the artificial setting of the texture type of respective sub-partitions.

(3d-2) The association algorithm of the sub-partitions is acquired based on the texture category of individual valid sub-partitions.

According to a computing method of an eigenvalue corresponding to the texture category of the sub-partitions, an algorithm Talg for computing the eigenvalue of the sub-partitions, namely the association algorithm of the sub-partitions, is obtained.

For example, if the texture category of the sub-partition 640 is fingerprint type, the eigenvalue algorithm associated with the sub-partition 640 is to calculate the number of segments with bifurcation points in the texture; if the texture category of the sub-partition 641 is stripe type, the eigenvalue algorithm associated with the sub-partition 641 is to calculate the number of stripes of the texture.

In practical application, an algorithm table for establishing the relationship between texture categories and algorithms can be established in advance. According to the algorithm table, the sub-partition association algorithm is obtained.

(3d-3) The sub-partition association algorithm is employed to obtain the eigenvalue of individual valid sub-partitions.

The sub-partition association algorithm Talg is used to obtain the eigenvalue Tval of respective sub-partitions, where Tval may be but not limited to a text, a graphic, a numerical value, an image, or a combination thereof.

(3e) The location of individual valid sub-partitions is obtained according to the location of respective sub-partitions relative to the image of the tag in the official product image.

A computing method, in which the location of respective sub-partition relative to the image of the tag 610 is adopted as an identifier of respective sub-partitions, is referred to as sub-partition location Tloc.

For example, a distance from a center of individual sub-partitions to a center of the image of the tag 610 and an angle between a line connecting there between and the upper boundary line are combined for the computation of the relative position of the sub-partitions to obtain the location Tloc of respective sub-partitions.

(3f) A serial number of the official product image is obtained; the serial number of the official product image, the sub-partition generation strategy, the feature of the official product image and the official product image are stored in the memory in an one-to-one correspondence.

The feature of the official product image include a sub-partition texture category, a sub-partition association algorithm, a sub-partition location and sub-partition eigenvalue of respective sub-partitions of the official product.

(3f-1) An information from the encoder in the official product image is decoded to obtain the serial number of the tag.

(3f-2) The official product image, the sub-partition generation strategy, the feature of the official product image and the serial number of the official product image are stored in the memory in the one-to-one correspondence.

The sub-partition type Ttype, the sub-partition association algorithm Talg, the sub-partition location algorithm Tloc and the eigenvalue Tval are stored in the memory.

Preferably, step (3f-2) is specifically described as follows.

A data entity RT containing legal features of the official product is obtained according to the legal features of the official product. The feature of the official product image includes a sub-partition texture type, a sub-partition association algorithm, a location and eigenvalue of respective sub-partitions of the official product.

In this embodiment, a data entity RT(Ttype, Talg, Tloc, Tval) is used to record the sub-partition type Ttype, the sub-partition association algorithm Talg, the sub-partition location algorithm Tloc and the eigenvalue Tval of the sub-partition.

Each valid sub-partition generates a data entity RT, and the data entities RT of all sub-partitions constitute the feature Plegal of the official product image 600.

A product has and only has one official product feature Plegal, namely the official product legal feature.

Preferably, the serial number of the tag is used as a primary key to store the official product image, the sub-partition generation strategy and the data entity RT in the memory.

The serial number iPsn of the tag can be obtained by decoding the information in the encoder 630 in the official product image, where the tag serial number iPsn is used as the primary key to store the serial number iPsn of the official product image, the official product image 600, the partitioning strategy Pstrategy and the image feature Plegal of the official product in the memory.

(3g) The feature of the official product image is repeatedly checked. If the image feature of official product is not unique, the texture category of sub-partition is adjusted, and steps (3d-3f) are repeated to re-obtain the feature of the official product image.

Preferably, after the image feature Plegal of the official product is generated, the repeatability test is performed. In order to avoid the repetition, the texture type Talg of some sub-partitions shall be adjusted or the manual intervention should be adopted.

It can also be set to allow the repetition to exist.

(4) A user product image to be identified is matched and authenticated using a similar partition matching method of the texture image eigenvalue based on the identity of an image of the tag and the feature of the official product image to determine an authenticity.

(4a) An image of an identification area of a user product to be identified is collected using the image acquisition device to obtain a second image.

When certifying the authenticity of a product, an imaging device is used to photograph the identification area of the product to be identified, to generate a second image 700 in which a relatively complete image of the tag 710 exists.

(4b) The second image is subjected to perspective transformation to acquire a user product image according to a coordinate of respective anchor points of the tag in the second image using the image analyzing and processing method.

The method of analyzing and processing the image is adopted to standardize the second image and obtain the user product image.

(4b-1) A coordinate cPi of respective anchor points of the tag in the second image is obtained using the image analyzing and processing method.

The coordinates of the anchor points 711, 712, 713, 714 in the second image 700 are obtained as coordinates of the transformation reference points, and the results are recorded as (cP1,cP2,cP3,cP4).

(4b-2) A second image perspective transformation matrix cM is acquired by using the coordinate cPi of the anchor points in the second image as a source image feature point of the perspective transformation and bPi+cPx as a target image feature point of the perspective transformation;

In this embodiment, the perspective transformation matrix cM is generated by using (cP1, cP2, cP3, cP4) as source image feature points for perspective transformation and (BP1+CP4, BP2+CP4, BP3+CP4, BP4+CP4) as target image feature points for perspective transformation. The coordinate values of bPk (k=1, 2, 3, 4) and cP4 are (u1, v1) and (u2, v2), bPk cP4), respectively. The new coordinates of (u3, v3) are generated by bPk+cP4, where u3=u1+u2, and v3=v1+v2.

(4b-3) The second image is subjected to perspective transformation using the second image perspective transformation matrix cM to obtain the user product image.

The second image 700 is subjected to perspective transformation using the second image 700 to generate a user product image 800.

(4c) A serial number of the tag in the user product image is identified to obtain corresponding official product image information.

A serial number of the tag is extracted from the encoder 830 in the user product image 800 to be identified, denoted as cPsn. The feature Plegal of the official product image and the partition strategy Pstrategy of the tag serial number cPsn which are obtained in step (3) are queried.

(4d) The user product image is divided into a plurality of second sub-partitions according to the sub-partition generation strategy of the official product image corresponding to the serial number of the tag.

The sub-partition generation strategy specified in the feature of the official product image Plegal generates a valid sub-partition group of the user product image 800, which is record as {cR}.

(4e) The second valid sub-partitions is performed matching based on the location of the first sub-partitions of the official product image corresponding to the serial number of the tag and the association algorithm of the first sub-partitions to determine an authenticity of the user product to be identified.

Whether the eigenvalue of any sub-partition in the official product image characteristic is matched with the valid sub-partition in the user product image is determined. The following steps are used to determine whether any sub-partition ir carried by the feature of the official product image Plegal is matched by {cR}. When the matching rate of the sub-partition of the feature of the official product image Plegal is greater than a certain predetermined value, such as 95, the product is regarded as genuine product and a “positive” conclusion is generated, otherwise a “negative” conclusion is generated, wherein the matching rate=(number of matched sub-partitions/total number of sub-partitions)×100.

(4e-1) A location of respective second sub-partitions of the user product image is obtained According to the location of the first sub-partition relative to the image of the tag in the official product image.

The location of the sub-partition of the user product sub partition {CR} is obtained.

(4e-2) Whether there is at least one of the second sub-partitions in the user product image matching any one of the first sub-partitions in the official product image with respect to location is determined. If not, a conclusion that the product to be identified is fake is obtained; if yes, step (4e-3) is performed.

There is a sub-partition cr in the user product sub-partition {cr}, which is the same or approximately the same the sub-partition location Tloc value of a sub-partition ir in the official product sub-partition {ir}, then cr is the equivalent sub-partition of ir.

(4e-3) Any pair of the second sub-partition cr of the user product image and the first sub-partition ir of the official product image matching each other are obtained; and an eigenvalue of the second sub-partition cr of the user product image is obtained according to an association algorithm of first sub-partition ir of the official product image.

A pair of the second sub-partitions cr and ir in the user product sub-partition {CR} is obtained, which is equivalent to the official product sub-partition {ir}. A sub-partition association algorithm of ir is obtained, and the eigenvalue of cr with the algorithm marked by ir is calculated.

(4e-4) Whether the eigenvalue of the second sub-partition cr of the user product image is consistent with the eigenvalue of the first sub-partition ir of the official product image is determined, if yes, a conclusion that the eigenvalue of the second sub-partition cr of the user product image is consistent with the eigenvalue of the first sub-partition ir of the official product image is obtained, if not, step (4e-5) is performed.

ir is considered to be matched with cr in the case that their share the same eigenvalue.

(4e-5) A plurality of similar partitions is generated based on the second sub-partition cr of the user product image; where the similar partitions are the same with the second sub-partition cr of the user product image except for the position in the user product image.

If it's still not matched, similar sub-partitions of multiple cr are generated based on cr. The similar sub partitions have the same properties as cr except for different positions and sizes.

(4e-6) Eigenvalues of respective similar partitions sequentially are obtained according to the association algorithm of the second sub-partition ir of the official product image; determine whether the eigenvalue of at least one similar partition is consistent with and the eigenvalue of the first sub-partition ir of the official product image, if yes, a conclusion that the user product to be identified is authentic is obtained; if not, steps (4e-3)-(4e-6) are repeated to compare all second sub-partitions with all first sub-partitions.

If there is an eigenvalue of a similar sub-partition being the same as that of ir, it is considered that cr matches ir.

Steps (4e-3)-(4e-6) are repeated to match and compare all sub-partitions.

(4e-7) A matching rate between the first sub-partitions and the second sub-partitions is obtained according to the comparison result; in the case of the matching rate greater than a preset threshold, making a conclusion that the user product to be identified is authentic; wherein the matching rate is calculated according to the following formula: matching rate=(the number of second sub-partitions matching the first sub-partitions/total number of the second sub-partitions)×100%.

When the matching rate of the feature of the official product image Plegal sub-partitions is greater than a certain predetermined value (e.g. 95), the product is regarded as genuine products and a “positive” conclusion is generated, otherwise a “negative” conclusion is generated; where the matching rate=(number of matched sub-partitions/total number of sub-partitions)×100%.

Optionally, if the user product image (800) is too poor in clarity and too small in size to obtain serial number and meet the application requirements, an “uncertain” conclusion is generated.

### Embodiment 2

The authentication of a batch of products called “Produce” is performed herein based on a batch of tags called “Tag” using the method of the invention. “Produce” can be air-dried fish or others vacuum packaged in a transparent packaging bag in reality, and “Tag” is a tag with a special structure based on the method.

In this embodiment, the tag has the following characteristics.

1) Individual tags have the same shape, size and structure.

2) Individual tags have a unique serial number, which readably exists in individual tags as two-dimensional code or other forms.

3) The resolution of the printed image should not be lower than 350 DPI.

4) With regard to the individual content, the difference between the actual position and the preset position and the difference between the actual shape and the preset shape should not be greater than 2 PPI.

5) In use, individual tags are implanted in the identification area of respective Produce individuals to form an entirety. The displacement should be less than a predetermined value (such as 1 PPI).

6) In use, the “Tag” individuals and the “Produce” individuals are in one-to-one correspondence.

The product “Produce” has the following features.

1) The individual is a structural solid or is packaged to form a solid.

2) All individuals are similar in appearance.

3) Each individual has a unique and stable texture pattern at a similar surface position and is unique within the range of Produce. The area where the texture pattern is located is called the identification area.

The method provided herein is specifically described as follows.

(1) A tag with a unique identity is obtained.

(1a) A tag structure with a unique identity is obtained.

The structure of the tag used in this embodiment is shown in FIG. 1, which is rectangular and includes a locator 110, a two-dimensional code 120, a delimiter 140 and a directing device 130.

The locator includes four anchor points, namely icon 111, icon 112, icon 113 and icon 114.

The two-dimensional code 120 carries a tag serial number.

The direction pointed by the directing device 130 is vertical to the lower boundary line of the tag and faces upward, which is started with the icon 113 and ended with the icon 114.

The delimiter 140 refers to the four boundary lines of the tag.

(1b) The tag is obtained based on the tag structure.

(1c) An image of the tag is collected using an image acquisition device.

A standard image of the tag is generated by shooting the tag from a front top view with an imaging device. The shooting visual distance bL is 120 mm, and the imaging resolution bD is 350 DPI.

(1d) Coordinates bPi of the anchor points in the image of the tag images in a coordinate system with any one of the anchor points as an origin are obtained using an image analyzing and processing method, wherein i is a number of the anchor points and is selected from 1, 2, 3 . . . and n.

In the pixel coordinate system shown in FIG. 2 where the icon (114) is adopted as the origin, the coordinates of respective anchor points are calculated according to the steps indicated by the following pseudo codes of the C-like language:

for (i = 0; i <w; i ++) {
n = the number of intersection points of the straight line (u = i) in the
image,
if (4 == n) {
t = V value of the second intersection point in the U-axis direction;
b = V value of the third intersection point in the U-axis direction;
exit;

}

}
for (i = 0; i <w; i ++) {
n = the number of intersection points of the straight line (V = i) in the
image,
if (4 == n){
l = V value of the second intersection point in the V-axis direction;
r = V value of the third intersection point in the V-axis direction;
exit;

where w is the width of the image and h is the height of the image.

It can be obtained from the above codes that the coordinates of icon 110 are (r,t) and denoted as bP1;

the coordinates of icon 111 are (r,b) and denoted as bP2;

the coordinates of icon 113 are (l,b) and are denoted as bP3;

the coordinates of the icon 114 are (l,t) and are denoted as bP4.

In this embodiment, bP1, bP2, bP3 and bP4 are coordinates of the feature point of the target image in the standard perspective transformation, and are denoted as (bp1, bP2, bP3, bP4).

Optionally, the distances between the anchor points 111 and 112, 112 and 113, 113 and 114, and 114 and 111 are calculated.

Optionally, a direction pointed by the directional pattern 120 is calculated to be 90 degrees herein, which indicates that the directional pattern 120 is perpendicular to the lower boundary of the standard image of the tag 100 and points to the upper boundary.

(1e) The tag, the image of the tag and the identity of the image of the tag are stored in a memory.

The identity of the image of the tag includes the coordinates of the anchor points of the image of the tag, the visual distance and quality when acquiring the tag structure image, and the serial number information of the tag.

The tag, the image of the tag 100, the coordinates (bp1, bP2, bP3, bP4) of the image of the tag anchor points, and the range of visibility and quality when acquiring the image of the tag are stored in the memory.

(2) The tag is implanted into a product identification area with a unique texture feature on a surface of the product.

(3) An image of the identification area on the surface of the product implanted with the tag as an official product image is collected using an image acquisition device; and a multi-partition computing method of a texture image eigenvalue is adopted to acquire a feature of the official product image.

(3a) The image of the product identification area on the surface of the product implanted with the tag is collected using the image acquisition device to obtain a first image.

The first image 500 is obtained by photographing a product identification area with an imaging device, and is denoted as G1, which is shown in FIG. 3.

The pixel coordinates (u,v) of the anchor point 511, the anchor point 512, the anchor point 513 and the anchor point 514 in the first image G1 are denoted as pP1, pP2, pP3 and pP4 respectively in the coordinate system shown in FIG. 3.

(3b) The official product image is obtained by using the method of analyzing and processing the image to perform perspective transformation according to the coordinates of the anchor point of the tag in the first image G1.

(3b-1) The coordinate pPi of respective anchor points of the tag in the first image G1 is acquired using the image analyzing and processing method.

The coordinates pP1, pP2, pP3, and pP4 of the anchor points of the first image G1 are calculated by image sub-processing.

(3b-2) A perspective transformation matrix iM of the first image is obtained using the coordinate pPi of respective anchor points of the first image as a source image characteristic point of the perspective transformation and bPi+pPx as a target image characteristic point of the perspective transformation, where x is a number of the anchor point used as an origin.

In this embodiment, pP4 is the origin and has values of (u1, v1), so that the coordinates of the target image feature point of the perspective transformation of the first image G1 are calculated as follows: bPi′=bPi+pPx, namely:

bP1′=bP1+(u1,v1)

bP2′=bP2+(u1,v1)

bP3′=bP3+(u1,v1)

bP4′=bP4+(u1,v1).

A new coordinate is obtained by the addition operation, of which the U component is the sum of the two U components on the right and the V component is the sum of the two V components on the right.

(3b-3) The first image is subjected to perspective transformation using the perspective transformation matrix iM of the first image to obtain the official product image.

The perspective transformation matrix IM of the first image is generated using the coordinates (pP1, pP2, pP3, pP4) of the first image anchor points as the source feature points for perspective transformation, and the coordinates (bP1′, bP2′, bP3′, bP4′) of the target image feature point of the perspective transformation of the first image is used as the target feature points for the generation of the perspective transformation matrix iM of the first image. The official product image 600 is obtained by image perspective transformation of the official product image G1 using iM, and recorded as G2, which is shown in FIG. 4.

(3c) The official product image is divided into a plurality of valid sub-partitions using a preset sub-partition generation strategy.

(3d) A texture category of respective sub-partitions and an association algorithm of the sub-partitions are obtained; and an eigenvalue value of respective valid sub-partitions is obtained according to the texture category and the association algorithm.

In this embodiment, the preset sub partition generation strategy is to use the center point of the official product image G2 as a reference point, and divide the official product image G2 with warp and weft to generate a plurality of sub partitions. The interval distance between warp and weft is preset to 10 mm. In practical application, the distance between warp and weft is an empirical value, and the value used herein is preferable. The value used herein has been demonstrated to be the best choice through repeated tests and verification.

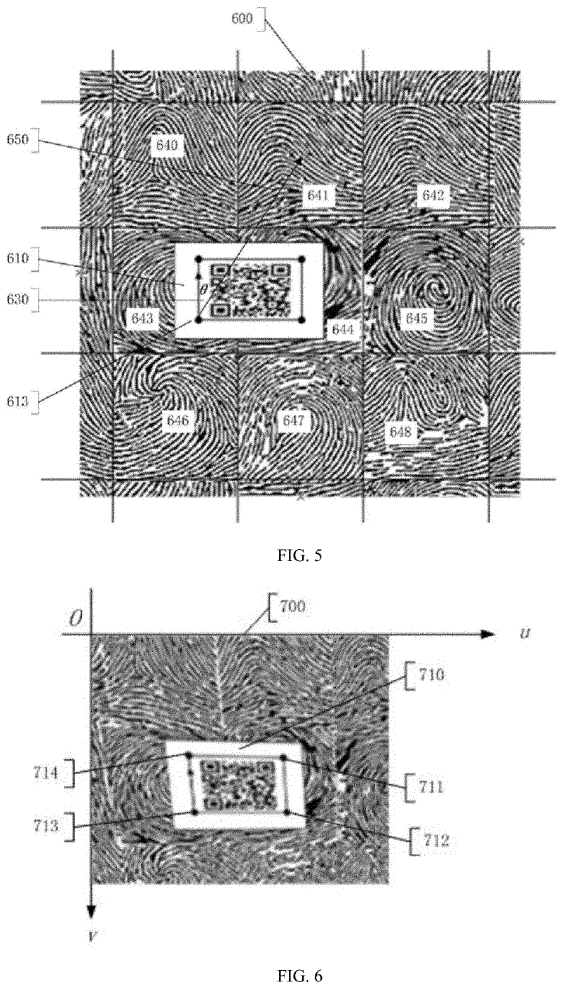

The result generated from the above segmentation method is shown in FIG. 5. It can be seen from the figure that nine partitions are generated, respectively, partition 640, partition 641, partition 642, partition 643, partition 644, partition 645, partition 646, partition 647 and partition 648. The partitions of G2 are recorded as iR, and the 9 partitions are combined to form a partition group of G2.

Preferably, all sub-partitions are screened to eliminate sub-partitions that do not intersect with the tag to obtain valid sub-partitions.

In this embodiment, based on the image analyzing and processing, seven partitions, namely, partition 640, partition 641, partition 642, partition 645, partition 646, partition 647 and partition 648, that do not intersect with the tag 610 are selected from the partition group. Seven partitions are valid partitions of G2, which are combined together to form a valid partition group of the official product image G2.

Preferably, based on the image analyzing and processing, one or more partitions are selected from the valid partition group by adopting a predetermined strategy, and in this embodiment, all candidate partitions in a total of 7 are selected. The selected partitions are used as authentication partitions for matching in the subsequent steps, and are combined together to form the valid sub-partition {iR} of the official product image G2.

(3d) The texture category of respective valid sub-partitions and the association algorithm of the sub-partitions are obtained

(3d-1) The texture category of respective valid sub-partitions is acquired.

In this embodiment, four texture categories are predefined, respectively Tux1, Tux2, Tux3 and Tux4, where Tux1 is a fingerprint type, Tux2 is a stripe type, Tux3 is a spot type, and Tux4 is a general type. In an embodiment, the texture category that does not belong to Tux′, Tux2 and Tux3 is set to Tux4.

For respective sub-partitions iR of the valid sub-partition {iR} of the official product image G2, the texture category of the iR is assigned to R_type. Since the texture of the embodiment is similar to the fingerprint texture, R_type is set to Tux_1. In the practical application, the sub-partitions are selected automatically by a machine according to the texture feature, or by manual operation, or by the combination of the machine and the manual operation.

(3d-2) The association algorithm of the sub-partitions are acquired based on the texture category of respective valid sub-partitions.

In this embodiment, a corresponding table of texture categories and algorithms is predefined to establish the analogous relationship between texture categories and algorithms. According to the set texture category, the eigenvalue calculation algorithms for the texture category are respectively defined to Alg1, Alg2, Alg3 and Alg4. Among them, Alg1 is used to calculate the number of line segments with bifurcation points; Alg2 is used to calculate the number of line segments with calculation endpoints on the upper and lower edges respectively; Alg3 is used to count the number of spots; and Alg4 is used to calculate the number of pixels with gray value less than 128, where Tux1, Tux2, Tux3 and Tux4 respectively corresponds to Agl1, Agl2, Agl3 and Agl4.

According to the predefined the corresponding table of texture category and algorithm, the associated algorithm R_agl is assigned to the sub-partition iR. Since in the corresponding table of category and algorithm, the algorithm corresponding to Tux1 is agl 1, R_agl is set to Alg1.

(3d-3) The eigenvalue of respective valid sub-partitions is obtained using the associated algorithm of the sub-partitions.

The algorithm Alg1 is used to calculate the eigenvalue of the valid sub-partition iR of the official product image, which is recorded as R_value. In this embodiment, the eigenvalue refers to the number of bifurcated line segments in iR.

(3e) A location of respective valid sub-partitions is obtained according to a location of respective sub-partitions relative to the image of the tag in the official product image.

According to the position of the sub-partition relative to the image of the tag in the official product image, the iR sub-partition location is assigned, i.e., the identifier R_id. The value of R_id is represented by (d, a), where d is the distance between a centre of the iR and the tag 610, and a is the included angle caused by the clockwise rotation of the included angle 620 between the directional line 620 and the directed straight line 650 and the coincidence of the included angle 650.

(3f) A serial number of the official product image is obtained; and the serial number of the official product image, the sub-partition generation strategy, the feature of the official product image and the official product image are stored in the memory in an one-to-one correspondence.

The feature of the official product image comprises a sub-partition texture category, a sub-partition association algorithm, a sub-partition location and the sub-partition features value of respective sub-partitions of the official product image.

(3f-1) An information from the encoder in the official product image is decoded to obtain the serial number of the tag.

The two-dimensional code 630 in the endorsed product image G2 is scanned to obtain a serial number of the tag, for example, SN0321, which is recorded as Psn as the serial number of the product.

(3f-2) The official product image, the sub-partition generation strategy, the feature of the official product image and the serial number of the official product image are stored in the memory in the one-to-one correspondence.

A data entity R_object is generated, and the sub-partition location Rid, the sub-partition texture category R_type, the sub-partition association algorithm R_agl and the sub-partition eigenvalue R_value obtained in the above steps are stored in the R_Object. In this embodiment, the data entity R_Object is a C++ class object.

Preferably, a data entity is constructed for the official product valid sub-partition {iR}, denoted as G2T, and all data entities R_object are stored in G2T. G2T is referred to as a legal feature of the product numbered PSN.

Preferably, the official product image to G2, the first image G1, and the official product image anchor point coordinates pP1, pP2, pP3, and pP3 are stored using Psn as a master.

Preferably, the official product image legal features G2T are stored with PSN as the main health so that the official product image legal features G2T can be queried and retrieved. In this embodiment, G2T is a C++ class object.

(4) A user product image to be identified is matched and authenticated using a similar partition matching method of the texture image eigenvalue based on the identity of an image of the tag and the feature of the official product image to determine an authenticity.

(4a) An image of an identification area of a user product to be identified is collected using the image acquisition device to obtain a second image.

The imaging device is used to capture the product recognition area to generate a second image 700, denoted as G3, which is shown in FIG. 6.

(4b) The second image is subjected to perspective transformation to acquire a user product image according to a coordinate of respective anchor points of the tag in the second image using the image analyzing and processing method.

(4b-1) A coordinate cPi of respective anchor points of the tag in the second image is obtained using the image analyzing and processing method.

The anchor points 711, 712, 713, and 714 in G3 are denoted as cP1, cP2, cP3, and cP4, respectively, in the coordinate system shown in FIG. 6.

(4b-2) A second image perspective transformation matrix Cm is acquired using the coordinate cPi of the anchor points in the second image as a source image feature point of the perspective transformation and bPi+cPx as a target image feature point of the perspective transformation.

CP4 is the origin and the value thereof is (u1, v1), then the coordinates of the target image feature points of the second image perspective transformation are:

bP1′=bP1+(u1,v1)

bP2′=bP2+(u1,v1)

bP3′=bP3+(u1,v1)

bP4′=bP4+(u1,v1)

A new coordinate can be resulted from the above addition operation. The U component of the result is the sum of the two U components on the right, and the V component is the sum of the two V components on the right.

The coordinates of the second image anchor points (cP1, cP2, cP3, cP4) are used as the source feature points of the perspective transformation, and the coordinates of the target image feature points (bP1′, bP2′, bP3′, bP4′) of the second image perspective transformation are used as target feature points to generate an perspective transformation matrix cM of the second image.

(4b-3) The second image is subjected to perspective transformation using the second image perspective transformation matrix cM to obtain the user product image.

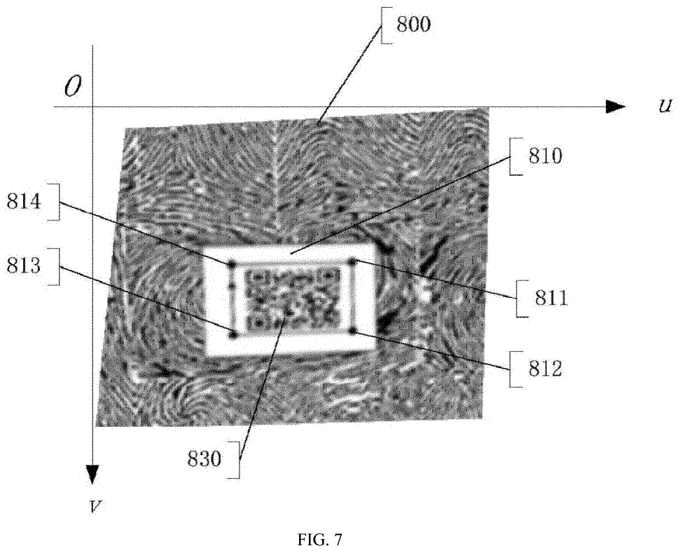

The second image is subjected to perspective transformation using the second image perspective transformation matrix cM to obtain a user product image 800, which is denoted as G4, as showed in FIG. 7.

(4c) A serial number of the tag in the user product image is identified to obtain corresponding official product image information.

The two-dimensional code (830) in the user product image G4 is scanned to obtain the serial number (e.g., SN0321) of the tag, which is recorded as uPsn.

(4d) The user product image is divided into a plurality of second sub-partitions according to the sub-partition generation strategy of the official product image corresponding to the serial number of the tag.

UPSN is used as the main key to find the legal feature G2T of the official product.

The official product valid sub-partition {iR} is extracted from the official product legal feature G2T.

According to the same method in G2T, the user product image G4 is partitioned to obtain the effective sub-partition {cR} of the user product image G4.

(4e) Matching on the second valid sub-partitions is performed based on the location of the first sub-partitions of the official product image corresponding to the serial number of the tag and the association algorithm of the first sub-partitions to determine an authenticity of the user product to be identified.

(4b-1) A coordinate cPi of respective anchor points of the tag in the second image is obtained using the image analyzing and processing method.

The location of the sub-partition of the valid sub-partition {cR} of the user product image G4 is obtained.

(4b-2) A second image perspective transformation matrix cM is acquired using the coordinate cPi of the anchor points in the second image as a source image feature point of the perspective transformation and bPi+cPx as a target image feature point of the perspective transformation.

Whether Ir exists in {cR} is determined, and if not, a “false” conclusion is generated.

Let R_id=(d1, a1) of iR, if iR exists in {cR}, then {cR} has a partition cR, cR=(d2, a2), and d1, a1, d2 and a2 satisfy the following conditions:

D1−d2<=X,a1−a1<=Y;

where X and Y are predetermined values and are set to 4 and 4, respectively, in the embodiment.

It is considered that iR exists in {cR}, and cR is the peer partition of iR, i.e., CR and iR match each other.

(4e-3) Any pair of the second sub-partition cr of the user product image and the first sub-partition ir of the official product image matching each other are obtained. and an eigenvalue of the second sub-partition cr of the user product image is obtained according to an association algorithm of first sub-partition ir of the official product image.

(4e-4) Whether the eigenvalue of the second sub-partition cr of the user product image is consistent with the eigenvalue of the first sub-partition ir of the official product image is determined, if yes, a conclusion that the second sub-partition cr of the user product image matches the first sub-partition ir of the official product image is obtained, if not, step (4e-5) is performed.

The eigenvalues of cR are calculated using the algorithm (R_agl) specified in iR, and the eigenvalues of iR and cR are compared. If the eigenvalues of iR and cR are equal, iR is successfully matched.

(4e-5) A plurality of similar partitions is generated based on the second sub-partition cr of the user product image; where the similar partitions are the same with the second sub-partition cr of the user product image except for the position in the user product image.

Similar partition sequences are constructed. The peer partition of iR in G4 is let to be cR, and cR has a range of (1, t, w, h) in G4 and is recorded as reg, where l and t are the pixel coordinates in the upper left corner of uR, and w and h are the width and height of uR.

Similar partitions of cR are generated and recorded as {cR′}. The similar partitions of uR are substantially the same with the similar partitions of cR in the properties except for the location and size. In this embodiment, 256 similar partitions of uR are generated by adjusting the value of (l, t, w, h).

(4e-6) Eigenvalues of respective similar partitions are sequentially obtained according to the association algorithm of the first sub-partition ir of the official product image. Whether there is at least one similar partition having an eigenvalue consistent with and the eigenvalue of the first sub-partition ir of the official product image, if yes, a conclusion that there is at least one similar partition having an eigenvalue matching the eigenvalue of the first sub-partition ir of the official product image is obtained; if not, a conclusion that there is no similar partition having an eigenvalue matching the eigenvalue of the first sub-partition ir of the official product image is obtained.

Steps (4e-3)-(4e-6) are repeated to compare all sub-partitions.

Eigenvalues of similar partitions are calculated until iR is matched.

If the iR is still not matched, it indicates a failure in the match of iR.

(4e-7) A matching rate between the first sub-partitions and the second sub-partitions is obtained according to the comparison result. In the case of the matching rate greater than a preset threshold, a conclusion that the user product to be identified is authentic is obtained; where the matching rate is calculated according to the following formula: matching rate=(the number of second sub-partitions matching the first sub-partitions/total number of the second sub-partitions)×100%.

When the value of (number of matched partitions in {iR}/number of partitions in {iR})×100 is less than 98, a “negative” conclusion is generated. Otherwise, a “positive” conclusion is generated.

It should be noted that the embodiments are merely illustrative of invention, and the invention is not limited thereto. For brevity, the known methods are not described herein in detail any more. Various modifications, replacements and variations made by those skilled in the art without departing from the spirit of the invention should fall within the scope of the invention

What is claimed is:

1. An anti-counterfeiting method based on a feature of a surface texture image of a product, comprising:
(1) obtaining a tag with a unique identity;
(2) implanting the tag into a identification area with a unique texture feature on a surface of the product;
(3) collecting, by an image acquisition device, an image of the identification area on the surface of the product implanted with the tag as an official product image; and acquiring a feature of the official product image by a computing method based on a texture image eigenvalue of multi-partition; and
(4) based on the identity of the tag and the feature of the official product image, authenticating a user product image to be identified by a matching method based on a texture image eigenvalue of similar partition to determine an authenticity.

2. The method of claim 1, wherein step (1) comprises:
(1-a) obtaining a structure of the tag with the unique identity;
wherein the structure of the tag comprises an encoder and a locator; the encoder has unique serial number of the product, and the locator comprises at least four anchor points provided at any position outside the encoder, the anchor points are used as reference points in subsequent image transformation;
(1-b) obtaining the tag based on the structure of the tag;
(1-c) collecting an image of the tag using the image acquisition device;
(1-d) obtaining coordinates bPi of the anchor points in the image of the image of the tags in a coordinate system with any one of the anchor points as an origin using an image analyzing and processing method, wherein i is the number of the anchor points and is 1, 2, 3 . . . or n; and
(1-e) storing the tag, the image of the tag and an identity of the image of the tag in a memory;
wherein the identity of the image of the tag comprises the coordinates of the anchor points in the image of the tag, a visual distance and a quality of the image of the tag during the collection of an image of the structure of the tag and a serial number of the tag.

3. The method of claim 2, wherein in step (1-a), the structure of the tag also comprises a delimiter and a directing device;
the delimiter is a boundary line of the locator; and
the directing device is a direction of the boundary line.

4. The method of claim 2, wherein step (3) comprises:
(3a) collecting the image of the product identification area on the surface of the product implanted with the tag using the image acquisition device to obtain a first image;
(3b) subjecting the first image to perspective transformation according to a coordinate of respective anchor points of the tag in the first image using the image analyzing and processing method to obtain the official product image;
(3c) dividing the official product image into a plurality of valid first sub-partitions using a preset sub-partition generation strategy;
(3d) obtaining a texture category of respective first sub-partitions and an association algorithm of the first sub-partitions; and obtaining an eigenvalue of respective valid first sub-partitions according to the texture category and the association algorithm;
(3e) obtaining a location of respective valid first sub-partitions according to a location of respective first sub-partitions relative to the image of the tag in the official product image; and
(3f) obtaining a serial number of the official product image; and storing the serial number of the official product image, the sub-partition generation strategy, the feature of the official product image and the official product image in the memory in an one-to-one correspondence;
wherein the feature of the official product image comprises the texture category of respective first sub-partitions, the association algorithm of the first sub-partitions, the location of respective first sub-partitions and the eigenvalue of respective first sub-partitions in the official product image.

5. The method of claim 3, wherein step (3) comprises:
(3a) collecting the image of the product identification area on the surface of the product implanted with the tag using the image acquisition device to obtain a first image;
(3b) subjecting the first image to perspective transformation according to a coordinate of respective anchor points of the tag in the first image using the image analyzing and processing method to obtain the official product image;
(3c) dividing the official product image into a plurality of valid first sub-partitions using a preset sub-partition generation strategy;
(3d) obtaining a texture category of respective first sub-partitions and an association algorithm of the first sub-partitions; and obtaining an eigenvalue of respective valid first sub-partitions according to the texture category and the association algorithm;
(3e) obtaining a location of respective valid first sub-partitions according to a location of respective first sub-partitions relative to the image of the tag in the official product image; and
(3f) obtaining a serial number of the official product image; and storing the serial number of the official product image, the sub-partition generation strategy, the feature of the official product image and the official product image in the memory in an one-to-one correspondence;
wherein the feature of the official product image comprises the texture category of respective first sub-partitions, the association algorithm of the first sub-partitions, the location of respective first sub-partitions and the eigenvalue of respective first sub-partitions in the official product image.

6. The method of claim 4, wherein step (3-b) comprises:
(3b-1) acquiring the coordinate pPi of respective anchor points of the tag in the first image using the image analyzing and processing method;
(3b-2) obtaining a perspective transformation matrix iM of the first image using the coordinate pPi of respective anchor points of the first image as a source image characteristic point of the perspective transformation and bPi+pPx as a target image characteristic point of the perspective transformation, wherein i is the number of the anchor points and is selected from 1, 2, 3 . . . and n, and x is a number of the anchor point used as an origin; and
(3b-3) subjecting the first image to perspective transformation using the perspective transformation matrix iM of the first image to obtain the official product image.

7. The method of claim 5, wherein step (3-b) comprises:
(3b-1) acquiring the coordinate pPi of respective anchor points of the tag in the first image using the image analyzing and processing method;
(3b-2) obtaining a perspective transformation matrix iM of the first image using the coordinate pPi of respective anchor points of the first image as a source image characteristic point of the perspective transformation and bPi+pPx as a target image characteristic point of the perspective transformation, wherein i is the number of the anchor points and is selected from 1, 2, 3 . . . and n, and x is a number of the anchor point used as an origin; and
(3b-3) subjecting the first image to perspective transformation using the perspective transformation matrix iM of the first image to obtain the official product image.

8. The method of claim 4, wherein step (3d) comprises:
(3d-1) acquiring the texture category of respective valid first sub-partitions;
(3d-2) acquiring the association algorithm of the first sub-partitions based on the texture category of respective valid first sub-partitions; and
(3d-3) obtaining the eigenvalue of respective valid first sub-partitions using the association algorithm of the sub-partitions.

9. The method of claim 5, wherein step (3d) comprises:
(3d-1) acquiring the texture category of respective valid first sub-partitions;
(3d-2) acquiring the association algorithm of the first sub-partitions based on the texture category of respective valid first sub-partitions; and
(3d-3) obtaining the eigenvalue of respective valid first sub-partitions using the association algorithm of the sub-partitions.

10. The method of claim 8, wherein step (30 comprises:
(3f-1) decoding an information from the encoder in the official product image to obtain the serial number of the tag; and
(3f-2) storing the official product image, the sub-partition generation strategy, the feature of the official product image and the serial number of the official product image in the memory in the one-to-one correspondence.

11. The method of claim 9, wherein step (30 comprises:
(3f-1) decoding an information from the encoder in the official product image to obtain the serial number of the tag; and
(3f-2) storing the official product image, the sub-partition generation strategy, the feature of the official product image and the serial number of the official product image in the memory in the one-to-one correspondence.

12. The method of claim 4, wherein step (4) comprises:
(4a) collecting an image of an identification area of a user product to be identified using the image acquisition device to obtain a second image;
(4b) subjecting the second image to perspective transformation to acquire a user product image according to a coordinate of respective anchor points of the tag in the second image using the image analyzing and processing method;
(4c) identifying a serial number of the tag in the user product image to obtain corresponding official product image information;
(4d) dividing the user product image into a plurality of second sub-partitions according to the sub-partition generation strategy of the official product image corresponding to the serial number of the tag; and
(4e) performing matching on the second valid sub-partitions based on the location of the first sub-partitions of the official product image corresponding to the serial number of the tag and the association algorithm of the first sub-partitions to determine an authenticity of the user product to be identified.

13. The method of claim 5, wherein step (4) comprises:
(4a) collecting an image of an identification area of a user product to be identified using the image acquisition device to obtain a second image;
(4b) subjecting the second image to perspective transformation to acquire a user product image according to a coordinate of respective anchor points of the tag in the second image using the image analyzing and processing method;
(4c) identifying a serial number of the tag in the user product image to obtain corresponding official product image information;
(4d) dividing the user product image into a plurality of second sub-partitions according to the sub-partition generation strategy of the official product image corresponding to the serial number of the tag; and
(4e) performing matching on the second valid sub-partitions based on the location of the first sub-partitions of the official product image corresponding to the serial number of the tag and the association algorithm of the first sub-partitions to determine an authenticity of the user product to be identified.

14. The method of claim 12, wherein step (4b) comprises:
(4b-1) obtaining a coordinate cPi of respective anchor points of the tag in the second image using the image analyzing and processing method;
(4b-2) acquiring a second image perspective transformation matrix cM by using the coordinate cPi of the anchor points in the second image as a source image feature point of the perspective transformation and bPi+cPx as a target image feature point of the perspective transformation; and
(4b-3) subjecting the second image to perspective transformation using the second image perspective transformation matrix cM to obtain the user product image.

15. The method of claim 13, wherein step (4b) comprises:
(4b-1) obtaining a coordinate cPi of respective anchor points of the tag in the second image using the image analyzing and processing method;
(4b-2) acquiring a second image perspective transformation matrix cM by using the coordinate cPi of the anchor points in the second image as a source image feature point of the perspective transformation and bPi+cPx as a target image feature point of the perspective transformation; and
(4b-3) subjecting the second image to perspective transformation using the second image perspective transformation matrix cM to obtain the user product image.

16. The method of claim 12, wherein step (4e) comprises:
(4e-1) obtaining a location of respective second sub-partitions of the user product image according to the location of the first sub-partition relative to the image of the tag in the official product image;
(4e-2) determining whether there is at least one of the second sub-partitions in the user product image matching any one of the first sub-partitions in the official product image with respect to location; if not, giving a conclusion that the product to be identified is fake; if yes, proceeding to step (4e-3);
(4e-3) obtaining any pair of the second sub-partition cr of the user product image and the first sub-partition ir of the official product image matching each other; and obtaining an eigenvalue of the second sub-partition cr of the user product image according to an association algorithm of first sub-partition ir of the official product image;
(4e-4) determining whether the eigenvalue of the second sub-partition cr of the user product image is consistent with the eigenvalue of the first sub-partition ir of the official product image, if yes, giving a conclusion that the eigenvalue of the second sub-partition cr of the user product image matches with the eigenvalue of the first sub-partition ir of the official product image, if not, proceeding to step (4e-5);
(4e-5) generating a plurality of similar partitions based on the second sub-partition cr of the user product image; wherein the similar partitions are the same with the second sub-partition cr of the user product image except for the position in the user product image;
(4e-6) sequentially obtaining eigenvalues of respective similar partitions according to the association algorithm of the second sub-partition ir of the official product image; determining whether the eigenvalue of at least one similar partition is consistent with and the eigenvalue of the first sub-partition ir of the official product image, if yes, giving a conclusion that there is at least one similar partition having an eigenvalue consistent with and the eigenvalue of the first sub-partition ir of the official product image; if not, giving a conclusion that there is no similar partition having an eigenvalue consistent with and the eigenvalue of the first sub-partition ir of the official product image; repeating steps (4e-3)-(4e-6) to compare all second sub-partitions with all first sub-partitions; and
(4e-7) obtaining a matching rate between the first sub-partitions and the second sub-partitions according to the comparison result; in the case of the matching rate greater than a preset threshold, making a conclusion that the user product to be identified is authentic; wherein the matching rate is calculated according to the following formula: matching rate=(the number of second sub-partitions matching the first sub-partitions/total number of the second sub-partitions)×100%.

17. The method of claim 13, wherein step (4e) comprises:
(4e-1) obtaining a location of respective second sub-partitions of the user product image according to the location of the first sub-partition relative to the image of the tag in the official product image;
(4e-2) determining whether there is at least one of the second sub-partitions in the user product image matching any one of the first sub-partitions in the official product image with respect to location; if not, giving a conclusion that the product to be identified is fake; if yes, proceeding to step (4e-3);
(4e-3) obtaining any pair of the second sub-partition cr of the user product image and the first sub-partition ir of the official product image matching each other; and obtaining an eigenvalue of the second sub-partition cr of the user product image according to an association algorithm of first sub-partition ir of the official product image;
(4e-4) determining whether the eigenvalue of the second sub-partition cr of the user product image is consistent with the eigenvalue of the first sub-partition ir of the official product image, if yes, giving a conclusion that the eigenvalue of the second sub-partition cr of the user product image matches with the eigenvalue of the first sub-partition ir of the official product image, if not, proceeding to step (4e-5);
(4e-5) generating a plurality of similar partitions based on the second sub-partition cr of the user product image; wherein the similar partitions are the same with the second sub-partition cr of the user product image except for the position in the user product image;
(4e-6) sequentially obtaining eigenvalues of respective similar partitions according to the association algorithm of the second sub-partition ir of the official product image; determining whether the eigenvalue of at least one similar partition is consistent with and the eigenvalue of the first sub-partition ir of the official product image, if yes, giving a conclusion that there is at least one similar partition having an eigenvalue consistent with and the eigenvalue of the first sub-partition ir of the official product image; if not, giving a conclusion that there is no similar partition having an eigenvalue consistent with and the eigenvalue of the first sub-partition ir of the official product image; repeating steps (4e-3)-(4e-6) to compare all second sub-partitions with all first sub-partitions; and
(4e-7) obtaining a matching rate between the first sub-partitions and the second sub-partitions according to the comparison result; in the case of the matching rate greater than a preset threshold, making a conclusion that the user product to be identified is authentic; wherein the matching rate is calculated according to the following formula: matching rate=(the number of second sub-partitions matching the first sub-partitions/total number of the second sub-partitions)×100%.
